(19) United States
(12) Patent Application Publication
(10) Pub. No.: US 2016/0104185 A1
(43) Pub. Date: Apr. 14, 2016

(54) Method for Viewing Advertisement by Direct Issuing of Advertisement Coupon by Viewer

(71) Applicant: YOUNG HYUN Seo, Daegu (KR)

(72) Inventor: Young Hyun Seo, Daegu (KR)

(21) Appl. No.: 14/894,244

(22) PCT Filed: May 26, 2014
(86) PCT No.: PCT/KR2014/004673

§ 371 Date: Nov. 25, 2015

(30) Foreign Application Priority Data
May 27, 2013 (KR) 10-2013-0059419

(51) Int. Cl. G06Q 30/02

(52) U.S. Cl. CPC G06Q 30/0214; G06Q 30/0277

(57) ABSTRACT

The present invention relates a method for viewing an advertisement by direct issuing of an advertisement coupon by a viewer; with the aim of providing a certain monetary benefit to the advertisement viewer when the viewer engages in viewing after having directly issued the advertisement coupon, which constitutes authority enabling an advertisement to be viewed, and accessed the advertisement by using the advertisement coupon. The method proposed in the present invention is a method for viewing an advertiser's advertisement by having the viewer directly issue the advertisement coupon which constitutes authority enabling the advertisement to be viewed by using an advertisement management server that receives a certain advertisement from the advertiser and registers the advertisement, and the method of the present invention comprises the steps of: (a) having the advertiser save a certain deposit in the advertisement coupon management server; (b) having the viewer access the advertisement management server and directly issue a certain advertisement coupon within the range of the deposit; and (c) accessing the advertisement management server through the advertisement coupon, and viewing an advertisement corresponding to the advertisement coupon.

### TECHNICAL FIELD

The present invention relates to a method for viewing an advertisement by directly issuing an advertisement coupon by a viewer himself/herself, and more particularly, to “a method for viewing an advertisement by directly issuing an advertisement coupon by a viewer himself/herself” with the aim of providing a certain monetary benefit to the advertisement viewer when the viewer engages in viewing the advertisement after having directly issued the advertisement coupon as a right to view the advertisement and accessed the advertisement by using the advertisement coupon.

### BACKGROUND ART

With a rapid increase in number of Internet users in recent years, e-commerce using the Internet has been rapidly spreading.

The e-commerce refers to the trading in whole or part of products or services in the cyber space through the Internet. With the spread of the Internet, the online sales of products and services online become as important as the offline sales. Therefore, various advertisements have been released online. An online advertising method is as follows.

As a basic online advertising method, each company opens its own homepage on the Internet and then advertises the company's products or the company through the homepage. However, this method is effective only on the people who access the homepage of the company. It is impossible to obtain advertising effects from the users who are not particularly interested in the company.

Meanwhile, there has been used a method in which a company may insert a banner in some popular portal sites, such as Yahoo!, Daum, Naver, and the like, or homepages of newspaper companies by paying a predetermined amount of an advertisement fee and a homepage of the company is connected upon a click on the banner advertisement.

In addition to the above-described methods, there are various online advertising methods which are being continuously developed. For example, the advertisement may be posted on a web page, or if a dedicated program is installed, whenever a user accesses the Internet, a moving picture advertisement, a still picture advertisement, and the like may be continuously displayed.

However, conventionally, advertising expenses paid are not necessarily in direct proportion to advertising effects, and an advertisement fee is not paid in proportion to an advertising effect but a flat-rate fee must be paid, which is quite unreasonable.

### DISCLOSURE

### Technical Problem

Accordingly, the present invention is suggested to solve the above-described problems, and directed to providing a method for offering an opportunity to expose many people to an advertisement to thereby maximize an advertising effect.

Further, the present invention provides a method for giving a predetermined monetary benefit not only to a first viewer of an advertisement but also numerous viewers who watch the advertisement through the first viewer.

In order to so, the present invention is directed to enabling a customer (hereinafter, referred to as “viewer”) to view an advertisement by directly issuing an advertisement coupon as a right to view the advertisement, or expose various customers to the advertisement by transmitting the advertisement coupon to a third person.

### Technical Solution

One aspect of the present invention provides a method for viewing an advertiser's advertisement by having a viewer directly issue an advertisement coupon as a right to view the advertiser's advertisement with an advertisement coupon management server that receives a predetermined advertisement from the advertiser and registers the advertisement, the method including: (a) having the advertiser accumulate a predetermined deposit in the advertisement coupon management server; (b) having the viewer access the advertisement coupon management server and directly issue a predetermined advertisement coupon within an amount of the deposit; and (c) having the viewer access the advertisement coupon management server through the advertisement coupon and view an advertisement corresponding to the advertisement coupon.

In the present invention, the advertisement coupon includes information of the advertiser, brief information of the advertisement, and information of the viewer who issues the advertisement coupon.

In the present invention, the advertisement coupon may be transmitted to a portable terminal of a third person who is registered as a member at the advertisement coupon management server and the third person may view the advertisement corresponding to the advertisement coupon.

In the present invention, if the third person views the advertisement, a predetermined amount of reserve is accumulated in accounts of the viewer who first issues the advertisement coupon and the third person, respectively. The advertisement coupon includes information of a URL accessible to the advertisement coupon management server in the form of text, a bar code, or a QR code.

### Advantageous Effects

An advertising method according to the present invention has the following effects.

1. An advertising effect is excellent since an advertisement is viewed only by a viewer interested in the advertisement.

2. A ripple effect is excellent since an advertisement coupon as a right to view an advertisement can be transmitted to a third person.

3. If a third person registered as a member views an advertisement, both a viewer who first issues an advertisement coupon and the third person can get a predetermined amount of reserve, and, thus, they may become active advertisement consumers.

### DESCRIPTION OF DRAWINGS

FIG. 1 illustrates a basic system for implementing the present invention.

### MODES OF THE INVENTION

Hereinafter, exemplary embodiments of the present invention will be described in detail with reference to the accompanying drawings. It should be noted that the same elements in the drawings will be designated by the same reference numerals, wherever possible. Further, detailed description of well-known functions or structures will be omitted when it is deemed that such description will cause ambiguous interpretation of the present invention.

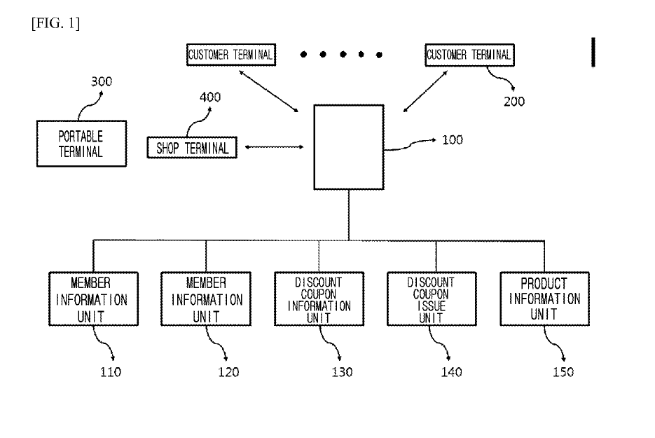

Hereinafter, a system as a prerequisite for the present invention will be schematically described with reference to FIG. 1.

FIG. 1 illustrates a basic system for implementing the present invention.

In FIG. 1, an advertiser or a viewer may implement the present invention described below after registering himself/herself as a member of an advertisement coupon management server 100 through a terminal 200, and if an advertisement coupon is transmitted to a portable terminal 300, the present invention may be implemented through a shop terminal 400 installed at an offline shop in the same manner as implemented online, which will be described below.

The present invention relates to a method for having a viewer himself/herself issue and use an advertisement coupon as a right to view an advertisement of an advertiser by the advertiser who wants to promote the advertisement. On the advertisement coupon issued by the viewer, a predetermined amount of money is clearly stated. If the viewer issues the advertisement coupon and then views an advertisement linked to the advertisement coupon, the predetermined amount of money is accumulated in an account of the viewer, and a deposit is reduced accordingly.

All the processes of the present invention are performed mainly by the advertisement coupon management server. Therefore, a concept of the advertisement coupon management server will be described.

The advertisement coupon management server according to the present invention refers to a server that provides an environment for posting a predetermined advertisement under contract with an advertiser so as to be viewed by a general consumer (hereinafter, referred to as “viewer”).

In the present invention, the advertiser needs to pay a predetermined amount of cost (hereinafter, referred to as “deposit”) under contract with an operator of the advertisement coupon management server.

Hereinafter, the present invention will be described.

[Advertisement Coupon Issuance Deposit]

The advertiser who wants to post an advertisement on the advertisement coupon management server needs to pay a predetermined deposit to the server operator.

If the deposit is paid, information about the deposit (hereinafter, also referred to as “advertisement coupon issuance deposit”) is stored in an account of the advertiser.

When a viewer views the advertisement by using an advertisement coupon, the deposit according to the present invention is reduced as much as an amount of cost for viewing the advertisement as stated on the advertisement coupon.

[Registration of Advertisement to be Used in Advertisement Coupon]

The advertiser can register at least one advertisement at various sites operated by the advertisement coupon management server or interworking with the advertisement coupon management server.

The registration can be performed by a predetermined procedure after the advertiser logs on to the advertisement coupon management server.

The advertisement to be registered may have various forms such as an advertisement file (video such as flash, AVI, and the like and image file such as PNG), a thumbnail image (image for advertisement file preview), a catchline, information of a URL connected upon a click, and the like.

[Setting of Option of Advertisement Coupon]

The advertiser may add various kinds of information to the advertisement registered by the advertiser himself/herself.

For example, the advertiser may set information of the advertiser, an amount of money for the advertisement coupon (an amount of advertisement cost to be paid to the viewer after the viewer views the advertisement), the number of times of viewing the advertisement (the viewer can get the amount of advertisement cost as reserve only when the viewer views the advertisement as many as the predetermined number of times of viewing the advertisement or numerous viewers view the advertisement by using the single advertisement coupon), and the like, which may be optional.

Further, in the present invention, a term of validity for viewing the advertisement may be set in order to promote the viewer to view the advertisement within a predetermined time period after issuance of the advertisement coupon.

Furthermore, in the present invention, the viewer who issues the advertisement coupon may transmit the advertisement coupon to portable terminals of his/her acquaintances such as friends or relatives and then promote them to view the advertisement.

[Issuance of Advertisement Coupon]

In order for the viewer to view an advertisement proposed in the present invention, the viewer needs to access a site interworking with the advertisement coupon management server and directly issue an advertisement coupon corresponding to the advertisement by the viewer himself/herself.

Firstly, the viewer accesses the site and selects an advertiser and then, selects an advertisement, which the viewer wants to watch, among advertisements of the advertiser.

Then, the viewer issues a predetermined information coupon (referred to as “advertisement coupon” in the present invention) as a right to view the advertisement.

An issuance process can be readily performed as provided in the site. When the viewer starts issuing an advertisement coupon, the advertisement coupon management server checks an advertisement coupon issuance deposit made by the advertiser.

As a result of the check, if the deposit is sufficient, the viewer can set options necessary for issuance of an advertisement coupon.

When the options are completely set, the advertisement coupon is issued.

If the advertisement coupon is issued, the advertisement coupon issuance deposit stored in the advertisement coupon management server is reduced as much as an amount of cost for currently issuing the advertisement coupon and then stored therein.

Further, the advertisement coupon management server may store various kinds of information such as information about issuance of an advertisement coupon, information about a viewer who issues the advertisement coupon, and the like.

Meanwhile, the advertisement coupon issued according to the present invention may include information about the viewer who issues the advertisement coupon in addition to various kinds of information optionally set by the advertiser or viewer.

[Viewing of Advertisement Coupon and Reserve]

If the viewer selects an advertisement of an advertiser and issues an advertisement coupon and then views the advertisement of the advertiser by using the advertisement coupon, a predetermined amount of cash (or electronic money such as points) is accumulated in an account of the viewer in the advertisement coupon management server.

For example, if the viewer views the advertisement of the advertiser one time by using the advertisement coupon directly issued by the viewer himself/herself, the advertisement coupon management server increases the number of times of viewing the advertisement by 1 in the viewer's account and checks whether or not conditions for completion of viewing the advertisement are satisfied.

The conditions for completion may include whether the advertisement is viewed as many as a predetermined number of times of viewing the advertisement, whether the advertisement is viewed within a predetermined term of validity for viewing the advertisement, whether the advertisement coupon is transmitted to acquaintances or other people (members) as many as a predetermined number of times, and the like.

If the conditions for completion of viewing the advertisement are satisfied, a predetermined amount of cash corresponding to the amount of cost for issuing the advertisement coupon is accumulated into the account of the viewer in the advertisement coupon management server, and the server deletes the information about the advertisement coupon.

If the conditions for completion of viewing the advertisement are not satisfied, the conditions for completion may be satisfied within a term of validity of the advertisement coupon.

[Transmission of Advertisement Coupon to Member so as to View Advertisement]

In order to maximize advertising effects, the present invention suggests a method in which an advertisement coupon issued by the viewer is transmitted to numerous members of the advertisement coupon management server so as to view an advertisement.

As such, the present invention offers an opportunity to expose more people to an advertisement.

Viewing of an advertisement by transmission of an advertisement coupon suggested in the present invention may be carried out as follows.

Firstly, a viewer issues an advertisement coupon of an advertiser selected by the viewer himself/herself.

Then, the viewer transmits the advertisement coupon to a portable terminal (a communication terminal, such as a smart phone, assigned a phone number) of at least one member.

A member A, a member B, a member C, and the like, receiving the advertisement coupon including information of the issuer may access the advertisement coupon management server through the received advertisement coupon and view the advertisement of the advertiser registered at the advertisement coupon management server.

If three members, the member A, the member B, and the member C, view the advertisement, the number of times of viewing the advertisement is 3, and information thereof is stored in the server.

Meanwhile, in the present invention, the number of times of viewing the received advertisement coupon may be limited to 1 or 3.

That is, in the present invention, the number of times of viewing an advertisement transmitted to a specific portable terminal may be limited in order to prevent a member from viewing the advertisement several times by using a single advertisement coupon.

However, in this case, the number of times of viewing the advertisement linked to the received advertisement coupon is limited, but the members A, B, and C may retransmit the advertisement coupon to other members.

As such, the advertisement can widely spread.

In the present invention, if a first advertisement coupon issuer transmits an advertisement coupon to third members and then many viewers view the advertisement, some of reserve to be accumulated in the name of the advertisement coupon issuer is distributed to the third members.

There has been described a basic case where an advertisement coupon issued by a viewer which is a member is transmitted to third persons which are members.

However, the third persons receiving the advertisement coupon may not be members.

If the third persons are not members, they may view the advertisement by using the received advertisement coupon. However, since they are not members, some of the reserve to be given to the advertisement coupon issuer is not distributed to them.

[Accumulation of Reserve after Viewing of Advertisement by Numerous Viewers (Including Members and Non-Members]

If a viewer generates an advertisement coupon of an advertiser who the viewer selects and views an advertisement, the viewer can be given a full amount of advertisement cost clearly stated on the advertisement coupon as reserve.

However, if the viewer transmits the advertisement coupon to numerous viewers (including members and non-members) and they individually view the advertisement by using the single advertisement coupon, after the advertisement is viewed, the reserve is distributed at a ratio set by the advertisement coupon management server.

[Limitation in Number of Times of Issuing Advertisement Coupon]

When a viewer (member or advertisement coupon issuer) issues and uses an advertisement coupon, “an advertisement coupon issuance deposit” of an advertiser may be insufficient and thus other viewers (members) cannot issue the advertisement coupon.

In the present invention, each viewer (member) is limited in the number of times of issuing an advertisement coupon in order to prevent issuance of too many discount coupons by a specific viewer (member).

Accordingly, in the present invention, if a viewer starts issuing an advertisement coupon, the advertisement coupon management server searches for information about issuance of advertisement coupons of the viewer from the viewer's account in the advertisement coupon management server. If the number of times of issuing an advertisement coupon is smaller than a predetermined number of times of issuance, the advertisement coupon is issued. If not, the viewer may be notified by a message indicating that the number of times of issuing an advertisement coupon exceeds the predetermined number of times of issuance.

[Increase in Number of Times of Issuing Advertisement Coupon]

In the present invention, if a viewer who issues an advertisement coupon satisfies a predetermined requirement prescribed in the service agreement of the advertisement coupon management server or accomplishes a result of viewing an advertisement with third members, the number of times of issuing an advertisement coupon can be variably increased.

Thus, a ripple effect thereof can be increased.

[Payment of Reserve to Viewer]

In the present invention, the advertisement coupon management server checks whether a predetermined condition (for example, accumulation of a predetermined amount of money, expiration of a predetermined time period, and the like) is satisfied on the basis of the service agreement of the advertisement coupon management server. If the condition is satisfied, cash is paid to the viewer using an account number input by the viewer when registering himself/herself as a member.

[Transfer of Advertisement Reserve to Others]

In the present invention, cash accumulated into the viewer's account can be transferred to a third person (member), and particularly, can be donated to a public foundation or the like.

The reserve can be transferred by automated credit transfer or general credit transfer.

As described above, the method for viewing an advertisement by issuing an advertisement coupon according to the present invention has the following characteristics.

1. A viewer can view an advertisement after directly issuing an advertisement coupon.

2. The advertisement coupon as a right to view the advertisement includes information of an advertiser, information of the issuer, information of the advertisement, and the like.

3. If the advertisement coupon is transmitted to a plurality of viewers and then they view the advertisement, the first issuer is also influenced by an effect of viewing the advertisement since the advertisement coupon includes the information of the issuer.

4. If the advertisement is viewed by many viewers by using the advertisement coupon, more benefits, for example, addition of reserve may be provided to the first issuer.

5. Therefore, in the present invention, an effect of enabling more viewers to view the advertisement by using the single advertisement coupon is excellent as compared with the prior conventional method, and a ripple effect of the advertisement is great.

Meanwhile, if an advertisement coupon is downloaded or transmitted to a portable terminal, the present invention may be implemented through a shop terminal installed at an offline shop in the same manner as implemented online.

Although the present invention has been described mainly in the case of a video advertisement, it can be applied to an image or text-type advertisement. Preferably, an advertisement coupon according to the present invention may include information of a URL accessible to the advertisement coupon management server in the form of text, a bar code, or a QR code.

1. A method for viewing an advertisement by directly issuing an advertisement coupon as a right to view the advertiser's advertisement by a viewer himself/herself with an advertisement coupon management server that receives a predetermined advertisement from an advertiser and registers the advertisement, the method comprising:
(a) having the advertiser accumulate a predetermined deposit in the advertisement coupon management server by using his/her terminal interworking with the advertisement coupon management server;
(b) having the viewer access the advertisement coupon management server by using his/her terminal interworking with the advertisement coupon management server, directly issue a predetermined advertisement coupon as the right to view the advertiser's advertisement online within an amount of the deposit, and store the advertisement coupon in the advertisement coupon management server; and
(c) if the viewer selects a predetermined advertisement corresponding to the advertisement coupon by using his/her terminal interworking with the advertisement coupon management server, transmitting the predetermined advertisement to the terminal of the viewer and having the viewer view the advertisement in the advertisement coupon management server,
wherein the advertisement coupon includes information of the advertiser, brief information of the advertisement, and information of the viewer who issues the advertisement coupon,
if the advertisement coupon is transmitted to a portable terminal of a third person who is registered as a member at the advertisement coupon management server and the third person selects the advertisement coupon transmitted to his/her portable terminal, the portable terminal of the third person accesses the advertisement coupon management server, and
if the third person views the advertisement corresponding to the advertisement coupon, a predetermined amount of reserve is accumulated in accounts of the viewer who first issues the advertisement coupon and the third person, respectively.
